(19) United States
(12) Patent Application Publication
(10) Pub. No.: US 2010/0228732 A1
(43) Pub. Date: Sep. 9, 2010

(54) INFORMATION OFFERING APPARATUS AND METHOD

(76) Inventors: Young-ho Rhee, Seoul (KR); Hyun-joo Kang, Suwon-si (KR); Ju-youn Lee, Seongnam-si (KR)

Correspondence Address: North Star Intellectual Property Law, PC, P.O. Box 34688, Washington, DC, 20043, US

(21) Appl. No.: 12/707,696

(22) Filed: Feb. 18, 2010

(30) Foreign Application Priority Data
Mar. 5, 2009 (KR) 10-2009-0018891

(51) Int. Cl. G06F 17/30

(52) U.S. Cl. 707/737; 707/E17.089

(57) ABSTRACT

An information offering apparatus and an information offering method are provided. The information offering apparatus is configured to arrange information, which is generated as a user uses services, according to a time period, group the arranged information, and then display the arranged information together with the time period.

### CROSS-REFERENCE TO RELATED APPLICATION

This application claims the benefit under 35 U.S.C. §119(a) of Korean Patent Application No. 10-2009-18891, filed on Mar. 5, 2009, in the Korean Intellectual Property Office, the entire disclosure of which is incorporated herein by reference for all purposes.

### BACKGROUND

1. Field

The following description relates to a technology for offering digital information, and more particularly, to a technology for offering web-based user personalized information.

2. Description of the Related Art

With the development of communication technologies, various functions can be is implemented in apparatuses such as mobile phones. A user may be able to use various functions including wireless internet, mobile multimedia broadcasting services, a camera, etc. through a mobile phone or similar device. In particular, such functions may be connected to, for example, messenger services, blogs, or a mobile device through an internet community, and are developing in the form of social interaction services.

Accordingly, the amount of information users can obtain through the internet community has enormously increased. To obtain desired information from such an enormous amount of information, the user may provide search details. However, according to conventional information searching, since information related to the user is provided by inputting specific keywords, the user may fail to obtain the desired information or waste time searching for desired contents.

### SUMMARY

In one general aspect, there is provided an information offering apparatus. The apparatus may include a group information offering unit configured to arrange information according to a time period to group and display the arranged information, the information generated as a user uses services, and a time period offering unit configured to display the time period.

The group information offering unit may group the arranged information into at least one group of a communicated persons group, a nearby peoples group, an enjoyed communities group, an emotion/activity group, a place group and a loved contents group that are used in a web application.

In the group information offering unit, a Short Message Service (SMS), a call history, and web based communication related text and video records may be grouped into the communicated persons group, in which the Short Message Service and the call history may be realized through a device and the text and video records may be realized through a web based service and related to a web based communication including a chatting, a guest book and a reply. A contact log may be grouped into the nearby peoples group, wherein the contact log may be formed based on a frequency of contact or location information of the user and other people, who use the application through the apparatus or the web-based service. Activity information, which may be formed based on a frequency of activity in a community in which the user is registered through the apparatus or the web-based service, may be grouped into the enjoyed communities group. Presence information, which may represent an emotion state or an activity state of the user who uses the apparatus or the web-based service, may be grouped into the emotion/activity group. Information about a location, at which the apparatus or the web-based service is connected or web-based contents are generated and used may be grouped into the place group; and contents usage information of the apparatus or the web-based service may be grouped into the loved contents group.

The time period may include year, month, day or time.

The information displayed into groups may be used for a recommendation service, which is configured to recommend friends, locations or web contents to the user.

In another aspect, an information offering method is provided. The method may include arranging information, which is generated as a user uses services, according to a time period, grouping the arranged information, and displaying the time period and the grouped information.

The grouping of the arranged information may include grouping the arranged information into at least one group of a communicated persons group, a nearby peoples group, an enjoyed communities group, an emotion/activity group, a place group, and a loved contents group that are to be used in a web application.

The grouping of the arranged information may include grouping a Short Message Service (SMS), a call history, and web based communication related text and video records into the communicated persons group, in which the Short Message Service and the call history may be realized through a device and the text and video records maybe realized through a web based service and related to a web based communication including a chatting, a guest book and a reply. The method may also include grouping contact log into the nearby peoples group wherein the contact log may be formed based on a frequency of contact or location information of the user and other people, who use the application through the apparatus or the web-based service, and grouping activity information formed based on a frequency of activity in a community in which the user is registered through the web-based service into the enjoyed communities group. The method may further include grouping presence information representing an emotion state or an activity state of the user who uses the apparatus or the web-based service into the emotion/activity group, grouping information on a location at which the apparatus or the web-based service is connected or web-based contents are created and used into the place group, and grouping contents usage information of the apparatus or the web-based service into the loved contents group.

Other features and aspects will be apparent from the following description, the drawings, and the claims.

### BRIEF DESCRIPTION OF THE DRAWINGS

FIG. 1 is a diagram illustrating an exemplary information offering system.

FIG. 2 is a diagram illustrating an exemplary information offering apparatus.

FIG. 3 is a diagram illustrating exemplary groups of information.

FIGS. 4 to 7 are views showing a screen configuration of the exemplary information offering apparatus.

FIG. 8 is a view showing a screen configuration of an exemplary web apparatus.

FIG. 9 is a flowchart illustrating an exemplary information offering method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

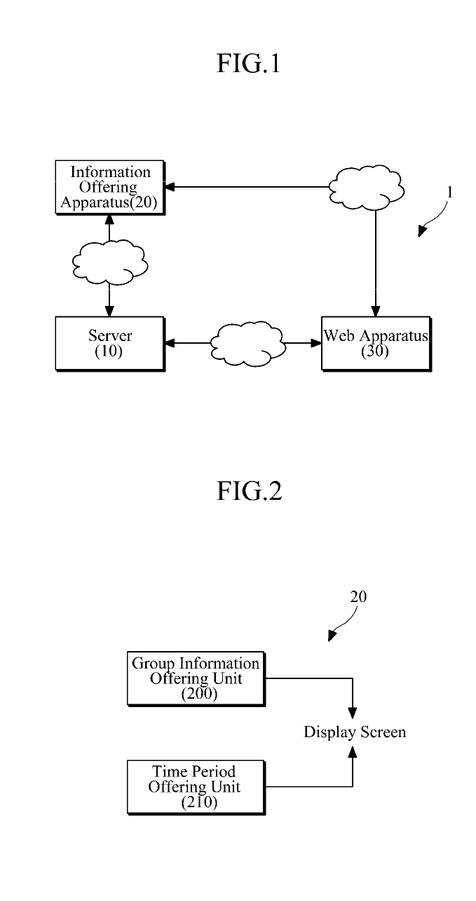

FIG. 1 illustrates an exemplary information offering system1. The system 1 for offering information, according to an exemplary embodiment, may include an information offering apparatus 20, a server 10 and a web apparatus 30. The server 10, the information offering apparatus 20 and the web apparatus 30 may be connected to each other through a wired/wireless network.

The information offering apparatus 20 may arrange information, which is generated as a user uses services, according to a time period, and then group the arranged information. The grouped information may then be displayed together with the time period. The service may include services provided through the information offering apparatus 20 and web-based services.

The information offering apparatus 20 may include various CE (Customer Edge) devices, such as a mobile phone, a smart phone, an IPTV (Internet Protocol Television), a PMP (Portable Multimedia Player), a navigation, an MP3 player, a mobile broadcasting receiver, a digital camera, and a computer. However, the information offering apparatus is not limited to these devices.

According to an exemplary embodiment, the information offering apparatus 20 may group the information, which is generated as the user uses service, into groups that are used in a web application. For example, the information offering apparatus 20 may group the generated information into at least one group of a communicated persons group, a nearby peoples group, an enjoyed communities group, an emotion/activity group, a place group and a loved contents group.

Meanwhile, the information offering apparatus 20 may receive grouped information from the server 10. In this case, if the server 10 groups information, which is generated as the user uses services, the information offering apparatus 20 may receive the grouped information from the server 10 and display the received information on a display screen.

The server 10 may be connected to the web apparatus 30 through the wired/wireless network. The web apparatus 30 may connect to a web community. In this case, information related to contents may be generated through the web community. The server 10 and the web apparatus 30 may be provided as individual units. However, the server 10 and the web apparatus 30 are not limited thereto and may be provided as a single integrated unit. That is, in another example, the server 10 may include a web apparatus 30 and may form groups by using the information, which is generated as the user uses services, to reconstruct the information.

FIG. 2 illustrates an exemplary information offering apparatus 20. The information offering apparatus 20 may include a group information offering unit 200 and a time period offering unit 210.

The group information offering unit 200 may arrange the information, which is generated as the user uses services, according to a time period, group the arranged information, and display the information on the display screen. The service may include the web-based service and services provided through the information offering apparatus 20.

The information generated as the user uses the information offering apparatus 20 may include, for example, log information generated by the information offering apparatus 20. The log information may be generated as the user communicates through the information offering apparatus 20. For example, the log information may include records of voice communication transmission/reception or short message transmission/reception. In addition, the log information may include personal information of the user who utilizes the information offering apparatus 20. The personal information may be written by the user, and include a phone number, a schedule, a memo, working information, and/or an alarm clock, for example. The personal information may include information about other people in addition to the information on the user. The log information may further include analysis information about frequencies, times and amounts in use of the voice communication transmission/reception, the short message transmission/reception, and/or personal information services, for example.

In addition, contents-usage information, for example, the information generated based on the use of services, may include contents information, which is generated or checked by the user of the information offering apparatus 20 through the wired/wireless network. The contents information, in one example, is provided in the form of multimedia data including, for example, a blog, an email, a music file, a moving picture file, a picture file or an image file. However, the contents information is not limited thereto. The information offering apparatus 20 may be a single unit, or a plurality of apparatuses using contents through the wired/wireless network.

The log information of the information offering apparatus 20 described above may represent a real life pattern of the user, and the contents-usage information may represent a virtual life pattern of the user.

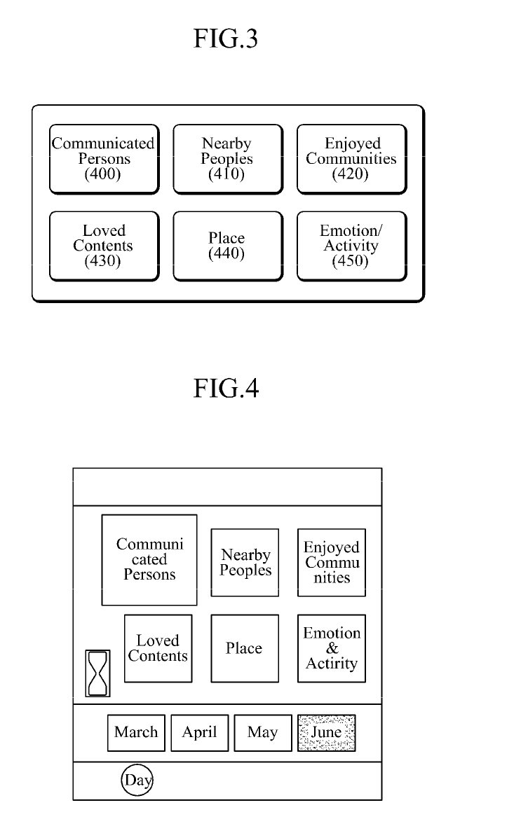

Meanwhile, according to an exemplary embodiment, the group information offering unit 200 may group the information, which is generated as the user uses services, into groups used in the web application. Referring to FIG. 3, the group information offering unit 200 may group the information, which is generated as the user uses services, into at least one group of a communicated persons group 400, a nearby peoples group 410, an enjoyed communities group 420, an emotion/activity group 430, a place group 440 and a loved contents group 450. The grouping by the group information offering unit 20 is described later.

The following are examples of information which may be grouped in each group. The communicated persons group 400 may represent information on people communicating through the information offering apparatus 20. The nearby peoples group 410 may contain human network information on acquaintances, such as friends, family, colleague at work, etc. who have a human network with the user. The enjoyed communities group 420 may include information related to the activity of the user in specific web communities. The emotion/activity group 430 may include information representing an emotion state or an activity state of the user. For example, the emotion state may include “pleasant”, “sad” or “happy”, and the activity state includes “meeting”, “away” and “busy”.

In addition, the place group 440 may represent information on a location at which the information offering apparatus 20 is disposed or web-based contents are generated. The location may be detected through a location detection technology or a sensor technology. The loved contents group 450 may include information on contents which are generated or stored by the user through the information offering apparatus 20.

The group information offering unit 200 may group a Short Message Service (SMS) and a call history that are realized through a mobile apparatus into the communicated persons group 400. In addition, the group information offering unit 200 may group a text record and a video record that are related to web-based communications such as chatting, a guest book, and a reply, for example, into the communicated persons group 400. The group information offering unit 200 may group contact information, for example, a contact log, into the nearby peoples group 410. The contact log may be formed based on the frequency of contact or the location information of the user and the people who use the application through the information offering apparatus 20 or the web-based service.

In addition, when the user is registered in a community and takes part in the community through the apparatus 20 or the web-based service, activity information formed based on the frequency of activity of the user may be grouped into the enjoyed communities group 420. Presence information which may represent the emotion state or the activity state of the user who uses the apparatus 20 or the web-based service may be grouped into the emotion/activity group 430.

In addition, information on a location at which the information offering apparatus 20 or the web-based service is connected or the web-based contents are generated may be grouped into the place group 440. Content usage information of the information offering apparatus 20 or the web-based service may be grouped into the loved contents group 450.

Since the group information offering unit 200 may display information based on the groups described above, the user may check a trend in use of the service in the information offering apparatus 20 and the web-based service without using a keyword search. The trend in use of the service may correspond to a life pattern of the user shown in the information offering unit 20 and the web-based service.

Meanwhile, the group information offering unit 200 may group information which is obtained when the user uses a service application of the web-based community. The service application of the web-based community may include at least one of a home, an archive, a buddy, a “whatabout”, a “peopleabout” and a community, for example.

The home may contain information corresponding to a profile of the user. The profile may include information on a current status, which may include a current location, an emotion state and an activity state of the user, a consumption pattern of the user in use of the contents and an acquaintance relationship of the user.

The archive may analyze, for example, a frequency of communication, a location, emotional variation, and/or statistics on contents of the user, to group or manage life data of the user and then apply the result of analysis to the profile of the user.

The buddy may provide a real-time presence of friends and an instant communication tool.

The whatabout may facilitate the sharing and recommendation of contents. The whatabout may provide a function of recommending/buying/selling contents based on the current location of the user.

The peopleabout may match and connect with new people, in which a profile of people having the same taste may be matched, thereby facilitating a meeting and communication of the people.

The community may have a function in which a new community of the user is generated, recommended and managed.

According to an exemplary embodiment, in the group information offering unit 200, the contact log of the peopleabout may be grouped into the nearby peoples group 410. Information on the community activity, which is performed in the community and includes posting, registration of contents, or downloading of contents, for example, may be grouped into the enjoyed communities group 420. Presence information, including the emotion state and the activity state included in the home, may be grouped into the emotion/activity group 430. Information on a contact location in the whatabout or the peopleabout or information on a location of contents may be grouped into the place group 440. Contents usage information, which is generated when the user uses contents of the home may be grouped into the loved is contents group 450.

The group information offering unit 200 may use a data mining scheme when grouping the information generated by the user. For example, the group information offering unit 200 may detect statistical rules or patterns from the information, which is generated as the user uses services, in a systematic and automatic manner, thereby categorizing the information into the groups described above. To this end, the group information offering unit 200 may determine a correlation between the information based on associative rules or sequential patterns, and then classify the information into the above groups according to a classification hierarchy scheme.

The group information offering unit 200 may display the grouped information based on, for example, the creation time of the information and according to a time period such as a Year, Month, Day or Time. The creation time of the information represents a time at which the web-based contents are generated. In this case, the grouped information may be displayed according to the time period such as a Year, Month, Week or 24 hours. For example, the group information offering unit 200 may display a tendency in user of the contents, a frequency in use of the contents, contents information used at a predetermined time, an expiration date of the contents and a type of contents.

According to an exemplary embodiment, the group information offering unit 200 may reconstruct information according to the time period through the data mining scheme using the patterns within time series scheme. Accordingly, information, which is generated during a predetermined period may be provided to the user of the information offering apparatus 20.

The information offering apparatus 20 may arrange and display the grouped information in the order of a participation on the web-based community, a frequency of communication, a frequency in use of the contents, a time in use of contents, or a location in use of the contents. For example, the information offering apparatus 20 may reconstruct the loved contents information in order with respect to time, at which the user uses the loved contents, and then is display the reconstructed contents.

Accordingly, the information offering apparatus 20 allows the user to check interested information based on the reconstructed information without having to perform additional keyword search.

In addition, the reconstructed information may be used in customized services such as a communication service with other users, a recommendation service or an advertisement service.

For example, a location-based customized service may be provided to users based on the reconstructed information. As another example, nearby peoples information on acquaintances, who create contents, may be provided to users based on the reconstructed information.

The time period offering unit 210 may display a time period. The time period includes a Year, Month, Day or Time. The creation time of the information represents a time at which the web based contents are generated. In this case, the time period offering unit 210 may display the time period such as a Year, Month, Week or 24 hours.

FIGS. 4 to 7 show a screen configuration of the exemplary information offering.

Referring to FIG. 4, the information offering apparatus 20 may arrange the information, which is generated as the user uses services, according to a time period, and group the information to display the grouped information and the time period. The displayed information may include at least one of communication information, nearby peoples information, enjoyed community information, emotion/activity information, place information and loved contents information. In this case, the information, grouped a predetermined period of time such as a Year, Month, Week or 24 hours, for example, and the time period are displayed on the screen.

For example, the information grouped during June is displayed on the screen together with the time period (June).

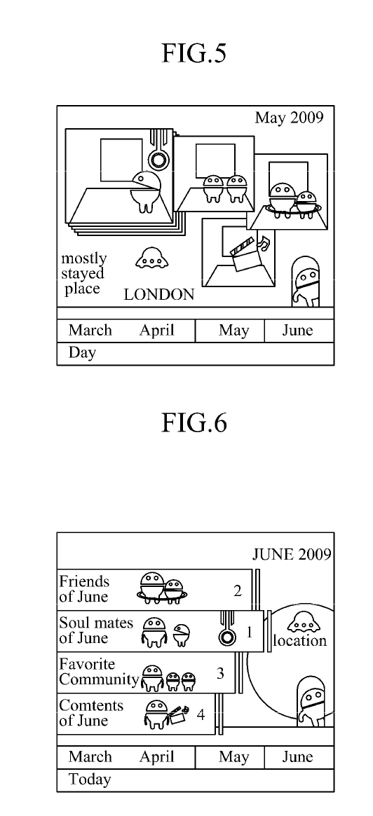

Referring to FIG. 5, according to another exemplary embodiment, if the user stays in London for a longer period of time than other places within a preset period, for example, in May, the information offering apparatus analyzes a frequency in use of contents in London and displays a list of used contents in the order of the frequency. The list of the contents may be arranged in the order of the highest frequency in use of the contents.

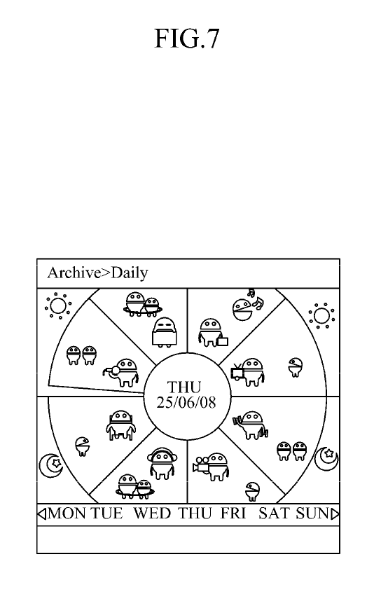

Referring to FIG. 6, according to another exemplary embodiment, the information offering apparatus may display friends, soul mates, a favorite community and contents on the screen corresponding to a preset period, for example, June. As another example, with reference to FIG. 7, the information offering apparatus may display at least one of communication information, nearby peoples information, favorite community information, emotion community information, place information, and loved contents information on a screen based on a preset period of usage of the information offering apparatus, for example 24 hours.

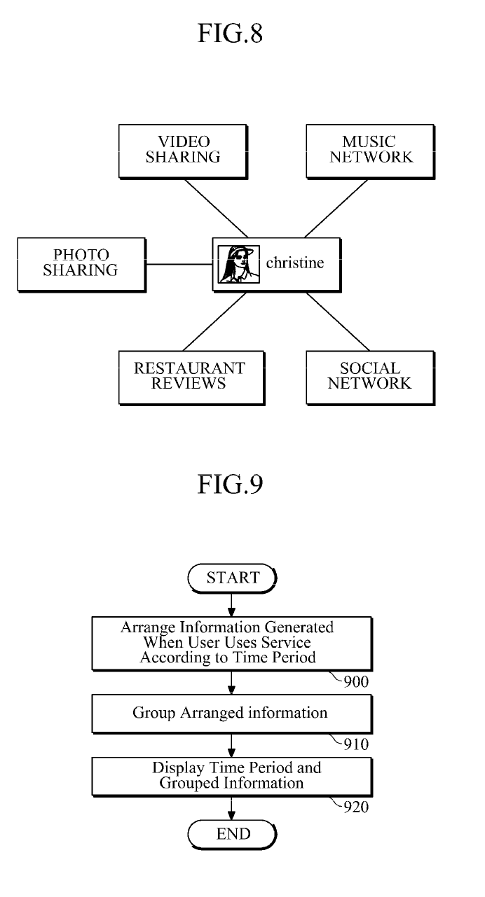

FIG. 8 shows a screen configuration of an exemplary web apparatus.

Referring to FIG. 8, the information offering apparatus may provide the grouped information to a web apparatus through a web. In this case, for example, the web apparatus provides users with a content sharing service, such as photo sharing, music sharing and video sharing; a location-based contents offering service, such as restaurant reviews and route recommendations; and a social network service representing a human network service.

FIG. 9 is a flowchart showing an exemplary information offering method according to an exemplary embodiment.

Referring to FIG. 9, the information offering apparatus according to an exemplary embodiment arranges information, which is generated as the user uses services, according to a time period (900). The time period includes a Year, Month, Day or Time, for example.

Subsequently, the information offering apparatus may group the arranged information (910). For example, the information offering apparatus may group the arranged information into at least one group of a communicated group, a nearby peoples group, an enjoyed communities group, an emotion/activity group, a place group, and a loved contents group that may be used in the web application.

Then, the information offering apparatus displays the time period and the grouped information (920).

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An information offering apparatus, the apparatus comprising:
a group information offering unit configured to arrange information according to a time period to group and display the arranged information, the information generated as a user uses services; and
a time period offering unit configured to display the time period.

2. The apparatus of claim 1, wherein the group information offering unit groups the arranged information into at least one group of a communicated persons group, a nearby peoples group, an enjoyed communities group, an emotion/activity group, a place group and a loved contents group that are used in a web application.

3. The apparatus of claim 2, wherein, in the group information offering unit,
a Short Message Service (SMS), a call history, and web based communication related text and video records are grouped into the communicated persons group, in which the Short Message Service and the call history are realized through a device and the text and video records are realized through a web based service and related to a web based communication including a chatting, a guest book and a reply;
a contact log is grouped into the nearby peoples group, wherein the contact log is formed based on a frequency of contact or location information of the user and other people, who use the application through the apparatus or the web-based service;
activity information, which is formed based on a frequency of activity in a community in which the user is registered through the apparatus or the web-based service, is grouped into the enjoyed communities group;
presence information, which represents an emotion state or an activity state of the user who uses the apparatus or the web-based service, is grouped into the emotion/activity group;
information about a location, at which the apparatus or the web-based service is connected or web-based contents are generated and used is grouped into the place group; and
contents usage information of the apparatus or the web-based service is grouped into the loved contents group.

4. The apparatus of claim 1, wherein the time period includes year, month, day or time.

5. The apparatus of claim 1, wherein the information displayed into groups is used for a recommendation service, which is configured to recommend friends, locations or web contents to the user.

6. An information offering method, the method comprising:
arranging information, which is generated as a user uses services, according to a time period;
grouping the arranged information; and
displaying the time period and the grouped information.

7. The method of claim 6, wherein the grouping of the arranged information comprises grouping the arranged information into at least one group of a communicated persons group, a nearby peoples group, an enjoyed communities group, an emotion/activity group, a place group and a loved contents group that are to be used in a web application.

8. The method of claim 7, wherein the grouping of the arranged information comprises:
grouping a Short Message Service (SMS), a call history, and web based communication related text and video records into the communicated persons group, in which the Short Message Service and the call history are realized through a device and the text and video records are realized through a web based service and related to a web based communication including a chatting, a guest book and a reply;
grouping contact log into the nearby peoples group wherein the contact log is formed based on a frequency of contact or location information of the user and other people, who use the application through the apparatus or the web-based service;
grouping activity information formed based on a frequency of activity in a community in which the user is registered through the web-based service into the enjoyed communities group;
grouping presence information representing an emotion state or an activity state of the user who uses the apparatus or the web-based service into the emotion/activity group;
grouping information on a location at which the apparatus or the web-based service is connected or web-based contents are created and used into the place group; and
grouping contents usage information of the apparatus or the web-based service into the loved contents group.
